(19) United States
(12) Patent Application Publication
(10) Pub. No.: US 2026/0208967 A1
(43) Pub. Date: Jul. 23, 2026

(54) AN AUTOMATED STORAGE AND RETRIEVAL SYSTEM COMPRISING A VEHICLE PEN AND A TRANSPORT VEHICLE, AND AN ASSOCIATED METHODS

(71) Applicant: AutoStore Technology AS, Nedre Vats (NO)

(72) Inventors: Jørgen Djuve Heggebø, Langhus (NO); Geir Vikingstad, Haugesund (NO); Kenneth Müller, Vormedal (NO)

(21) Appl. No.: 19/138,018

(22) PCT Filed: Jun. 11, 2025
(86) PCT No.: PCT/EP2023/084615

§ 371 Date: Jun. 11, 2025

(30) Foreign Application Priority Data
Dec. 16, 2022 (NO) 20221352

(51) Int. Cl. B65G 43/02; B65G 1/04

(52) U.S. Cl. CPC B65G 43/02; B65G 1/0464; B65G 2207/40

(57) ABSTRACT

It is described an automated storage and retrieval system (1) comprising: —a rail system (108) comprising a first set of parallel rails (110) extending in a first direction (X) across the top of a frame structure (100) formed by a plurality of upright members (102), and a second set of parallel rails (111) in the horizontal plane arranged in a second direction (Y) perpendicular to the first set of parallel rails (110), to guide movement of container handling vehicles (201; 301; 401) in the first direction (X) and the second direction (Y), and wherein the rail system (108) comprises an operating area (20); —a plurality of container handling vehicles (201; 301; 401) operating in the operating area (20); —a transport vehicle (501′) movable on the rail system (108), the transport vehicle (501′) comprising an enclosure (E) defining an enclosed first area (510) for transporting a person within, the enclosure comprising a lockable barrier (520′) configured to provide access for a person into the first area (510); —a second area (30) partitioned from the operating area (20); —a vehicle pen (60) between the operating area (20) and the second area (30), wherein the vehicle pen (60) defines a vehicle pen area (61) and comprises a lockable first barrier (31) for separating the vehicle pen area (61) from the second area (30), and a lockable second barrier (32) for separating the vehicle pen area (61) from the operating area (20); wherein the first barrier (31) of the vehicle pen is configured to: —lock when the second barrier (32) of the vehicle pen is unlocked thereby preventing passage of a person therethrough; and—unlock when the second barrier (32) of the vehicle pen is locked thereby allowing passage of a person therethrough, and wherein the lockable barrier (520′) of the transport vehicle is configured to:—lock when the second vehicle pen barrier (32) of the vehicle pen is unlocked thereby preventing passage of a person therethrough, and—unlock when the transport vehicle (501′) is positioned within the vehicle pen area (61) and the second vehicle pen barrier (32) of the vehicle pen is locked thereby allowing passage of a person therethrough. It is also described methods of moving a transport vehicle (501′) between a vehicle pen area (61) and an operating area (20) in an automated storage and retrieval system (1).

The invention relates to an automated storage and retrieval system for safe entry and exit of a person into a transport vehicle on a live grid via a vehicle pen. An associated method is also claimed.

### BACKGROUND AND PRIOR ART

FIG. 1 discloses a prior art automated storage and retrieval system 1 with a frame structure 100 and FIGS. 2, 3 and 4 disclose three different prior art container handling vehicles 201,301,401 suitable for operating on such a system 1.

The frame structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The frame structure 100 of the automated storage and retrieval system 1 comprises a rail system 108 arranged across the top of frame structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of parallel rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the frame structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set of parallel rails 110, and the second set of wheels 201c,301c,401c is arranged to engage with two adjacent rails of the second set of parallel rails 111. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of parallel rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may comprise a lifting frame 404d suspended from lifting bands 404a. The lifting bands 404a may provide power and communication between the container handling vehicle and the lifting frame 404d. The lifting frame 404d may comprise gripping engaging devices/grippers 404b for connection to gripping recesses of a storage container 106. Guide pins 404c assist in aligning the grippers 404b relative the gripping recesses of the storage container 106.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the frame structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 (showing a cavity-type container handling vehicles) and as described in e.g. WO2015/193278A1 and WO2019/206487A1, the contents of which are incorporated herein by reference.

FIG. 3 shows an alternative configuration of a container handling vehicle 301 with a cantilever construction (referred to as a cantilever-type container handling vehicle). Such a vehicle is described in detail in e.g. NO317366, the contents of which are also incorporated herein by reference.

The cavity-type container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity-type container handling vehicles 401 shown in FIGS. 4 and 5 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the frame structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the frame structure 100 or transferred out of or into the frame structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the frame structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a drop-off port column where the container handling vehicles 201,301,401 can drop off storage containers 106 to be transported to an access or a transfer station, and the second port column 120 may be a pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the frame structure 100 again once accessed. A port can also be used for transferring storage containers to another storage facility (e.g. to another frame structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different frame structures, e.g. as is described in WO2014/075937A1, the contents of which are incorporated herein by reference.

A storage system may also use port columns 119,120 to transfer a storage container between the rail system 108 on top of the frame structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device 116, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the frame structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

An objective of the invention is to provide safe access of operators or personnel on an active or “live” automated storage and retrieval system.

### SUMMARY OF THE INVENTION

The present invention is set forth and characterized in the independent claims, while the dependent claims describe other optional features.

The size of automated storage and retrieval systems are continuously increasing. To ensure a reliable operation for these systems there is a need to allow for fixing of problems occurring while the system is live. The proposed solution is a system and method for safe entrance of vehicles on a live automated storage and retrieval system, using a vehicle pen as entrance point between the hazardous operating area where the container handling vehicles operate and a safe area also named second area. This allows access to the transport vehicle when positioned in the vehicle pen without shutting down the automated storage and retrieval system. The vehicle pen comprises two lockable barriers, one facing towards the safe area, and the other towards the operating area. An interlock between these barriers ensures that only one of the barriers is allowed to be unlocked at a time. The vehicle pen and the transport vehicle together ensure a secure system for safe entry and exit into and out of the transport vehicle when the transport vehicle is positioned in the vehicle pen.

The lockable barrier of the transport vehicle can only be unlocked when the service vehicle is positioned in the vehicle pen and the lockable barrier towards the hazardous operating area is locked.

It is described an automated storage and retrieval system comprising:
a rail system comprising a first set of parallel rails extending in a first direction across the top of a frame structure formed by a plurality of upright members, and a second set of parallel rails in the horizontal plane arranged in a second direction perpendicular to the first set of parallel rails, to guide movement of container handling vehicles in the first direction and the second direction, and wherein the rail system comprises an operating area;
a plurality of container handling vehicles operating in the operating area;
a transport vehicle movable on the rail system, the transport vehicle comprising an enclosure defining an enclosed first area for transporting a person within, the enclosure comprising a lockable barrier configured to provide access for a person into the first area;
a second area partitioned from the operating area;
a vehicle pen between the operating area and the second area, wherein the vehicle pen defines a vehicle pen area and comprises a lockable first barrier for separating the vehicle pen area from the second area, and a lockable second barrier for separating the vehicle pen area from the operating area;
   wherein the first barrier of the vehicle pen is configured to:
lock when the second barrier of the vehicle pen is unlocked thereby preventing passage of a person therethrough; and
unlock when the second barrier of the vehicle pen is locked thereby allowing passage of a person therethrough, and wherein the lockable barrier of the transport vehicle is configured to:
lock when the second vehicle pen barrier of the vehicle pen is unlocked thereby preventing passage of a person therethrough, and
unlock when the transport vehicle is positioned within the vehicle pen area and the second vehicle pen barrier of the vehicle pen is locked thereby allowing passage of a person therethrough.

The transport vehicle may have a smaller cross-sectional area or footprint than the vehicle pen area such that there is available space for more than one transport vehicle within the vehicle pen area. For example, the vehicle pen area shall be of sufficient size to let a person enter the transport vehicle. In addition, the vehicle pen area shall be of sufficient size to accommodate a number of container handling vehicles in need of “simple” service. More advanced services which requires more time, may be performed e.g. in the second area.

Alternatively, the transport vehicle may have a cross-sectional area or footprint which is substantially equal to the vehicle pen area such that the transport vehicle occupies more or less the whole vehicle pen area.

The second area can be a so-called safe area where neither container handling vehicles nor transport vehicles can operate by self-movement. However, container handling vehicles in need of service may be pushed or lifted into the second area for service.

The second area may have rails connected to the rails in the vehicle pen area or it may not have rails.

The transport vehicle is a vehicle of sufficient size for a person, e.g. an operator or other personnel, to enter into or onto it. When the person is inside or on the transport vehicle, he/she is protected against the container handling vehicles operating in the operating area. The enclosure may encircle the person or it may provide all round protection, for example, through including a roof. When the person is inside or on the transport vehicle, the person is protected against the container handling vehicles operating in the operating area.

The transport vehicle may be a transport vehicle with a primary task of transporting a person or personnel.

Alternatively, the transport vehicle may be a vehicle which normally has other primary tasks such as e.g. storage container handling tasks, picking tasks, etc. and which has a person transport or personnel transport function as a secondary task.

The lockable barrier of the transport vehicle and the lockable first barrier of the vehicle pen are preferably operable between a state where they are unlocked allowing passage therethrough and a state where they are locked preventing passage therethrough, such that the barriers prevent passage of a person except when the transport vehicle is arranged inside the vehicle pen area and the second barrier of the vehicle pen is locked.

The lockable barrier of the transport vehicle can thus preferably only be unlocked and opened when the transport vehicle is positioned within the vehicle pen and the second barrier of the vehicle pen is locked. This minimizes the risk of collision with any container handling vehicles during entry and exit into and out of the first area.

When the lockable barriers are locked, they are also always closed preventing passage of a person therethrough.

When the lockable barriers are unlocked, they are either open allowing passage of a person therethrough or they can be opened such that a person is allowed to pass therethrough.

The storage columns below the vehicle pen can be used for storing containers with maintenance tool. Alternatively, or additionally, specialized containers movable by the container handling vehicles, such as a dedicated camera container for inspecting the rails or upright members, or a dedicated cleaning container for cleaning the rails, can be stored in the storage columns below the vehicle pen.

The vehicle pen may comprise rails for guiding movement of the container handling vehicles and the transport vehicle.

The vehicle pen area may comprise a number of parking positions for the transport vehicle and at least one of the parking positions may comprise means for locking the transport vehicle in place when positioned at the parking position.

The means for locking may comprise a brake or stake to lock with the rails. This serves as a safety feature preventing the transport vehicle from unintentional movement. The means can also be a bolt that lowers to at the same time unlock the barrier of the vehicle.

The barrier of the transport vehicle and the first barrier of the vehicle pen are preferably fail-safe locked. This ensures that the barrier of the transport vehicle and the first barrier of the vehicle pen are always locked when the transport vehicle is not positioned within the vehicle pen thereby eliminating the risk of unintentional unlocking and opening of the vehicle barrier.

The transport vehicle may comprise a first set of wheels for driving in the first direction and a second set of wheels for driving in the second direction.

The transport vehicle may comprise a wheel lift mechanism operable between a first position in which the first set of wheels is above the second set of wheels such that the second set of wheels is in contact with the rail system, and a second position in which the first set of wheels is below the second set of wheels such that the first set of wheels is in contact with the rail system.

The transport vehicle may comprise a wheel drive motor for driving the first set of wheels and/or the second set of wheels. There may be one wheel drive motor for driving both the wheels in the first set of wheels and the wheels in the second set of wheels. Alternatively, there may be one wheel drive motor for driving the first set of wheels and one motor for driving the second set of wheels.

The automated storage and retrieval system may comprise a control system which comprises a transmitter and a receiver for communication with the container handling vehicles and the transport vehicle.

The transport vehicle may comprise an emergency stop, and the emergency stop may comprise a transmitter configured to transmit an emergency stop signal to the control system for shutting down the automated storage and retrieval system.

The emergency stop can be connected to the control system such that upon a signal from the emergency stop, the control system can immediately shut down the automated storage and retrieval system. For example, the emergency stop may comprise a transmitter and the control system may comprise a receiver for receiving a signal from the transmitter.

Similarly, the second area may comprise an emergency stop with similar features and functions.

The transport vehicle may be configured to receive routing instructions from the control system to a position inside the vehicle pen area, and when it is verified that the transport vehicle is in the vehicle pen area and the second vehicle pen barrier is locked and the vehicle barrier and the first vehicle pen barrier are open, passage of a person therethrough is allowed.

The control system may comprise a verification device for verifying that the transport vehicle is inside the vehicle pen area.

The verification device may comprise one or more sensors.

The transport vehicle may comprise a locking mechanism and the vehicle pen area may comprise a complementary locking mechanism such as to prevent unintentional movement of the transport vehicle when in the vehicle pen area. This provides an additional safety measure for the unintentional movement of the transport vehicle when inside the vehicle pen area. The locking mechanism of the transport vehicle and the complementary locking mechanism of the vehicle pen area may mechanic, electro-mechanic, magnetic or any other locking mechanism which provides the required function.

The locking mechanism of the vehicle pen area may is preferably arranged at the first barrier such that the first barrier can only be unlocked when all of the transport vehicles present within the vehicle pen area are locked to the first barrier. And, as stated above, provided that the second barrier of the vehicle pen is locked. This will provide for even additional safety measures as it is prevented that the transport vehicles move unintentional when the first barrier is unlocked and thus personnel are within the vehicle pen area. It may be easier to prevent unintentional movement of the container handling vehicles present within the vehicle pen area because they can simply be shut down by pressing their emergency stop.

The transport vehicle may comprise a support to help stabilize the transport vehicle.

The support may be movable between a raised position where it is lifted from the rail system and a lowered position where it is in contact with the rail system.

The support is preferably configured to interact with the rail system. The support may interact with the rail system in order to stabilize the transport vehicle during entering and exit of a person. The support may be used in addition to lowering all wheels into contact with the rail system during entering and exit of a person. It may also provide for additional support which may be required when bringing container handling vehicles, tools etc. into or out of the first area of the transport vehicle.

The second area may be a safe area for performing service on the container handling vehicles and where the container handling vehicles are prevented from self-movement.

The operating area and the second area may be at the same height and the rails of the vehicle pen may be connected to the rails of the operating area such that the transport vehicle and the container handling vehicles can move on the rails when entering and exiting the vehicle pen area through the lockable first barrier.

The operating area and the second area may be arranged at different heights and the vehicle pen may be an elevator for transporting the container handling vehicles and the transport vehicle between the operating area and the second area. Such a solution using an elevator is for example shown in WO 2020/127060 A1.

The second area may be an area within the operating area.

The second area can be a temporary “island” within the operating area. The “island” may be a temporary or a permanent area. The temporary or permanent area may be used for protecting personnel when doing maintenance, repair and/or installation within the operating area. I.e., while the operating area is operational, i.e. “live”, the second area is protected from the operating area.

If the second area is for example a temporary area, it may serve as a safe area for e.g. performing maintenance or repair on:
parts of the rail system,
on upright members forming part of the frame structure, or
chargers for the container handling vehicles, where the chargers can be arranged within the temporary second area or in the proximity of the second area.

The automated storage and retrieval system may comprise a vehicle pen confirmation device operable by the person such that the person can confirm entry or exit into or out of the vehicle pen area through the first barrier of the vehicle pen.

The vehicle pen confirmation device may be a button or other confirmation device which informs the control system that the person has entered or exited the vehicle pen area such that the control system may perform necessary actions. Such necessary actions may be that, if the person enters the vehicle pen area, any transport vehicle or container handling vehicles present in the vehicle pen area is not allowed to move. Alternatively, if the person has confirmed exit from the vehicle pen area, any transport vehicle or container handling vehicles present in the vehicle pen area is allowed to move.

The transport vehicle may comprise an activation device operable by the person such that the person can confirm entry or exit into or out of the transport vehicle through the barrier of the transport vehicle.

The second barrier of the vehicle pen is preferably configured to be unlocked either:
if the person has confirmed entry into the transport vehicle via the activation device, or
if the person has confirmed exit out of the vehicle pen area via the vehicle pen confirmation device.

It is further described a method of moving a transport vehicle from an operating area into a vehicle pen area in an automated storage and retrieval system as defined above, the transport vehicle comprising a vehicle drive for self-movement and a wheel lift mechanism for changing movement direction and an enclosure which defines an enclosed first area for transporting a person within, the enclosure comprising a lockable barrier configured to provide access for a person into the first area, wherein the method comprises using a control system to:
request unlocking of the lockable second barrier;
verify that the first barrier is locked, if not wait for the first barrier to lock;
change state of the lockable second barrier to unlock;
instruct the transport vehicle to enter into the vehicle pen area through the second barrier;
request locking of the second barrier;
set vehicle drive to inhibited mode;
set vehicle wheel lift mechanism to inhibited mode;
request the lockable barrier of the transport vehicle to unlock, verify that the second barrier is locked, if not wait for the second barrier to lock;
request unlocking of the lockable first barrier;
change state of the lockable barrier to unlocked;
change state of the lockable first barrier to unlocked;
enter or exit the transport vehicle to or from the second area through the lockable barrier and the first barrier.

The term inhibited mode refers to a mode of the wheel lift mechanism and vehicle drive where these components are set to be inactive, i.e. they are not allowed to perform their dedicated functions of lifting or lowering one of the sets of wheels and drive the vehicle.

It is also described a method of moving a transport vehicle from a vehicle pen area to an operating area in an automated storage and retrieval system as defined above, the transport vehicle comprising a vehicle drive for self-movement and a wheel lift mechanism for changing movement direction and an enclosure which defines an enclosed first area for transporting a person within, the enclosure comprising a lockable barrier configured to provide access for a person into the first area, wherein the method comprises using a control system to:
request the lockable barrier to unlock;
request the lockable first barrier to unlock;
verify that the second barrier is locked, if not wait for the second barrier to lock;
enter the transport vehicle;
request the lockable barrier to lock;
change state of lockable barrier to locked;
request the first barrier to lock;
change state of the first barrier to locked;
set vehicle drive to operation mode;
set vehicle wheel lift mechanism to operation mode;
request the lockable second barrier to unlock;
instruct the transport vehicle to exit the vehicle pen area and enter into the operational area via the lockable second barrier.

The term operation mode when referring to the wheel lift mechanism and vehicle drive refers to normal operation mode, i.e. when the wheel lift mechanism is allowed to raise and lower one of the set of wheels and the vehicle drive is allowed to move the transport vehicle.

It is also described a method of entering a transport vehicle operating on an automated storage system as defined above, wherein the method comprises the steps of:
instructing the transport vehicle to exit the operating area and entering the vehicle pen area through the second barrier of the vehicle pen;
locking the second barrier of the vehicle pen;
unlocking the barrier of the transport vehicle and the first barrier of the vehicle pen;
entering the first area through the barrier of the transport vehicle and the first barrier of the vehicle pen;
locking the barrier of the transport vehicle and the first barrier of the vehicle pen; and
unlocking the second barrier of the vehicle pen;
instructing the transport vehicle to exit the vehicle pen area and entering the operating area through the second barrier of the vehicle pen.

The system may comprise a vehicle pen confirmation device operable by the person, and the method may comprise:
entering the vehicle pen area through the first barrier of the vehicle pen;
operating the vehicle pen confirmation device to confirm entry into the vehicle pen area.

If the person enters the vehicle pen area, any transport vehicle or container handling vehicles present in the vehicle pen area is not allowed to move.

The system may comprise a vehicle pen confirmation device operable by the person, and the method may comprise:
exiting the vehicle pen area through the first barrier of the vehicle pen;
operating the vehicle pen confirmation device to confirm exit out from the vehicle pen area.

If the person has confirmed exit from the vehicle pen area, any transport vehicle or container handling vehicles present in the vehicle pen area is allowed to move.

The transport vehicle may comprise an activation device operable by a person, and the method may comprise:
entering the first area of the transport vehicle through the barrier of the transport vehicle;
operating the activation device to confirm entry into the vehicle pen area.

The transport vehicle may comprise an activation device operable by a person, and the method may comprise:
exiting the first area of the transport vehicle through the barrier of the transport vehicle;
operating the activation device to confirm exit out of the vehicle pen area.

The automated storage and retrieval system may comprise a plurality of upright members and each storage column is defined by four of the upright members.

The rail system may be arranged on top of the upright members, the rail system comprising a first set of parallel rails and a second set of parallel rails arranged perpendicular to the first set of rails. The first and second set of rails providing a horizontal grid-based rail system defining a plurality of grid cells. The first and second set of rails of the rail system may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell”. In arrangements where one direction of rails has only a single track, the grid cell may extend a full rail-width on those sides.

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the automated storage and retrieval system and the goods to be stored. The gripping recesses may be arranged at an upper rim of the sidewalls. The outer horizontal periphery of the storage container is preferably rectangular.

The relative terms “upper”, “lower”, “below”, “above”, “higher” etc. shall be understood in their normal sense and as seen in a cartesian coordinate system.

The invention may be used in connection with storage containers and systems as described above. However, other areas where the disclosed automated storage and retrieval system and methods may be used is within vertical farming, micro-fulfilment or grocery/e-grocery.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a frame structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIG. 5 is a perspective view of the container handling vehicle in FIG. 4 without side and top panels;

FIG. 6A shows details of an exemplary transport vehicle for the automated storage and retrieval system;

FIG. 6B is a side view of a second example of a transport vehicle for the automated storage and retrieval system;

FIGS. 7A-7G are perspective views of an automated storage and retrieval system comprising an operating area, a second area and a vehicle pen between the operating area and the second area, and where the vehicle pen comprises a lockable first barrier separating the vehicle pen area from the second area and a lockable second barrier separating the vehicle pen area from the operating area, and where two container handling vehicles are positioned within the vehicle pen in all of the Figures, and where:

FIG. 7A shows a transport vehicle identical to the transport vehicle in FIG. 6A within the operating area and with a lockable barrier of the transport vehicle locked, and where the first lockable barrier and the second lockable barrier are both locked;

FIG. 7B shows that the lockable barrier of the transport vehicle is still locked, the second lockable barrier is unlocked and the first lockable barrier is still locked, and the transport vehicle is about to entering the vehicle pen through the lockable second barrier;

FIG. 7C shows that the lockable barrier of the transport vehicle is still locked, the second lockable barrier is still unlocked and the first lockable barrier is still locked, and the transport vehicle has entered the vehicle pen through the lockable second barrier;

FIG. 7D shows that the lockable barrier of the transport vehicle is still locked, the second lockable barrier is still locked and the first lockable barrier is still locked, and the transport vehicle is positioned next to the lockable first barrier inside the vehicle pen;

FIG. 7E shows that the lockable barrier of the transport vehicle is unlocked, the second lockable barrier is still locked and the first lockable barrier is unlocked, and the transport vehicle is still positioned next to the lockable first barrier inside the vehicle pen;

FIG. 7F is a similar view as FIG. 7E, but where another lockable first barrier between the vehicle pen area and the second area is unlocked, and the lockable barrier of the transport vehicle is still unlocked;

FIG. 7G is a similar view as FIG. 7F, but where a person has entered the vehicle pen area through the unlocked another lockable first barrier between the vehicle pen area and the second area;

FIGS. 8A-8C are perspective views of an automated storage and retrieval system comprising an operating area, a second area and a vehicle pen between the operating area and the second area, where a transport vehicle as exemplified in FIG. 6B is positioned inside the vehicle pen and the vehicle pen is of substantially the same size as the transport vehicle such that only one transport vehicle can be positioned inside the vehicle pen at the time, where:

FIG. 8A shows that a lockable first barrier separating the vehicle pen area from the second area is locked and a lockable second barrier separating the vehicle pen area from the operating area is unlocked;

FIG. 8B shows the same as FIG. 8A but from an opposite side than FIG. 8A;

FIG. 8C shows that the lockable first barrier separating the vehicle pen area from the second area is unlocked and the lockable second barrier separating the vehicle pen area from the operating area is locked;

FIG. 9 shows an automated storage and retrieval system where an operating area and a second area are at different heights and where a vehicle pen is an elevator for the container handling vehicles and the transport vehicle for transporting the container handling vehicles and the transport vehicle between the operating area and the second area.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

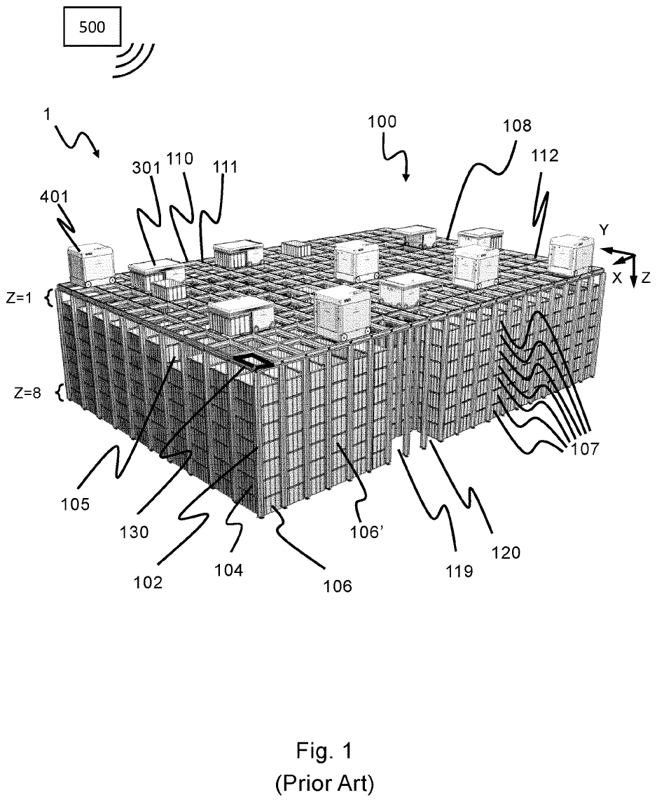

A frame structure 100 of the automated storage and retrieval system 1 may be constructed in a similar manner to the prior art frame structure 100 described above in connection with FIG. 1. That is, the frame structure 100 may comprise a number of upright members 102, and comprise a rail system 108 extending in the first direction (X direction) and the second direction (Y direction). I.e. the rail system 108 may be arranged on top of the upright members 102, the rail system 108 comprising a first set of parallel rails 110 and a second set of parallel rails 111 arranged perpendicular to the first set of rails 110. The first and second set of rails 110,111 providing a horizontal grid-based rail system 108 defining a plurality of grid cells 130. The first and second set of rails 110,111 of the rail system 108 may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell” 130. In arrangements where one direction of rails has only a single track, the grid cell 130 may extend a full rail-width on those sides.

The frame structure 100 may comprise storage compartments in the form of storage columns 105 provided between the members 102 wherein storage containers 106 may be stackable in stacks 107 within the storage columns 105.

The frame structure 100 can be of any size. In particular, it is understood that the frame structure can be considerably wider and/or longer and/or deeper than disclosed in FIG. 1. For example, the frame structure 100 may have a horizontal extent of more than 700×700 columns and a storage depth of more than twelve containers.

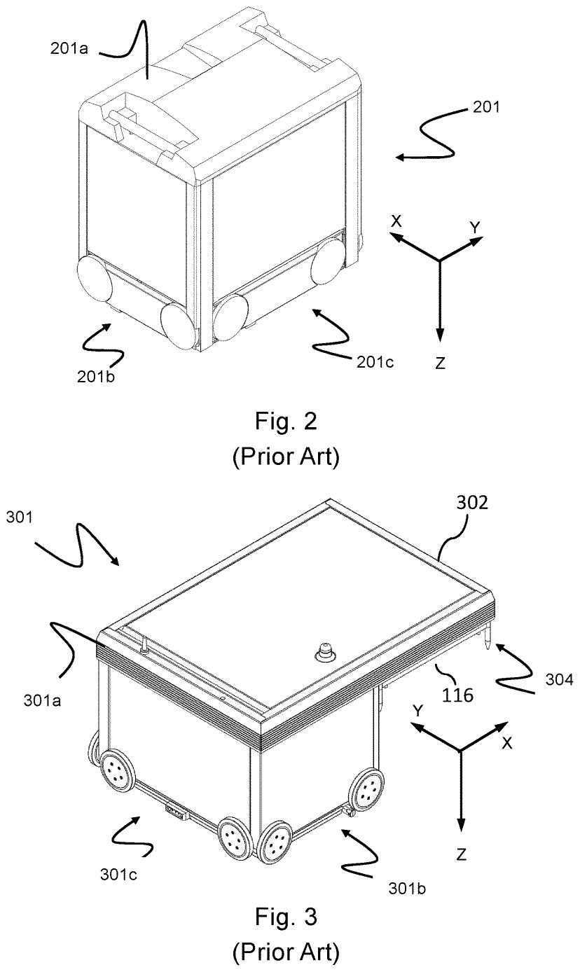

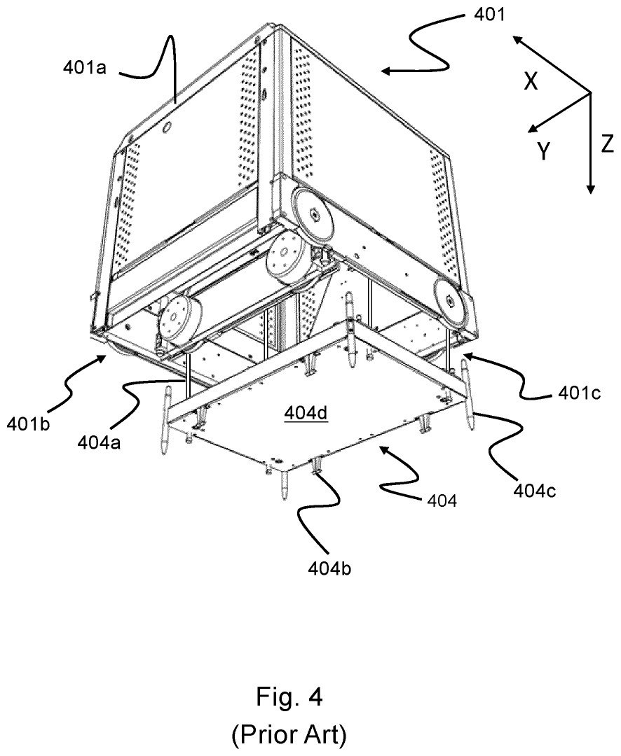

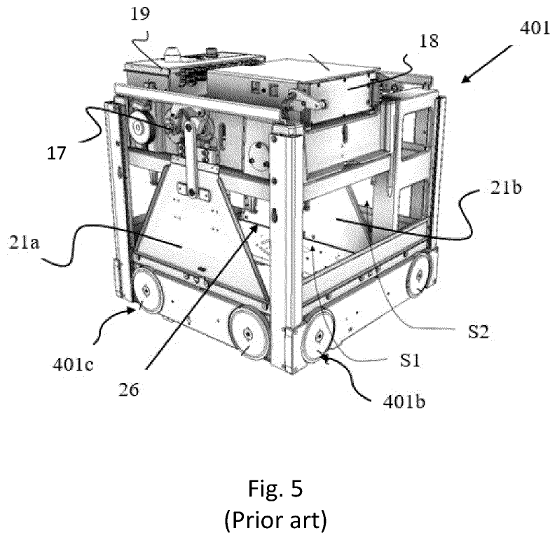

The prior art container handling vehicles comprising a cavity for accommodating a storage container (cavity-type container handling vehicles), see FIGS. 2, 4 and 5, have certain advantageous features. In particular, the guidance/support provided to a storage container when accommodated in the cavity entails that the cavity-type container handling vehicles may have increased acceleration/deceleration relative to the cantilever-type container handling vehicle 301 shown in FIG. 3.

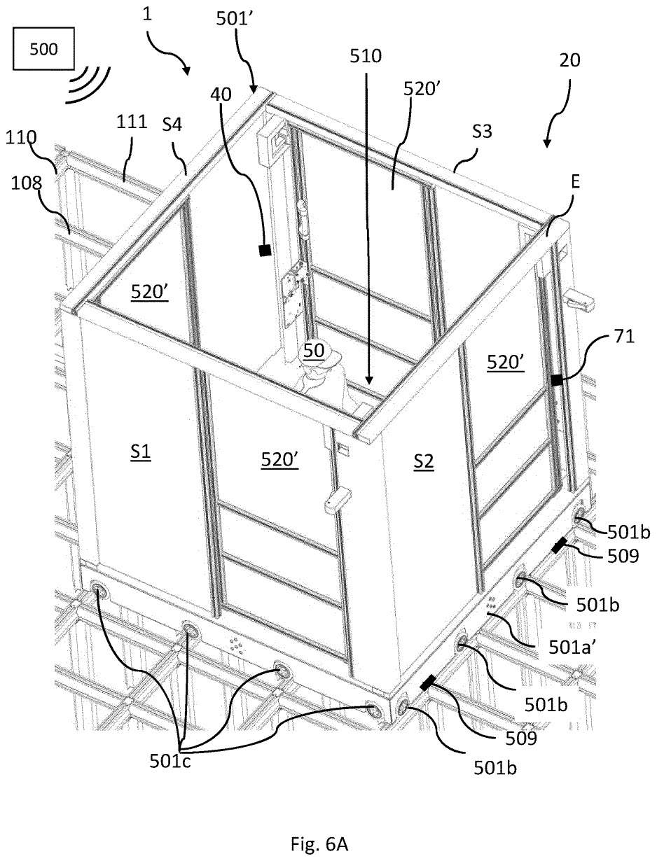

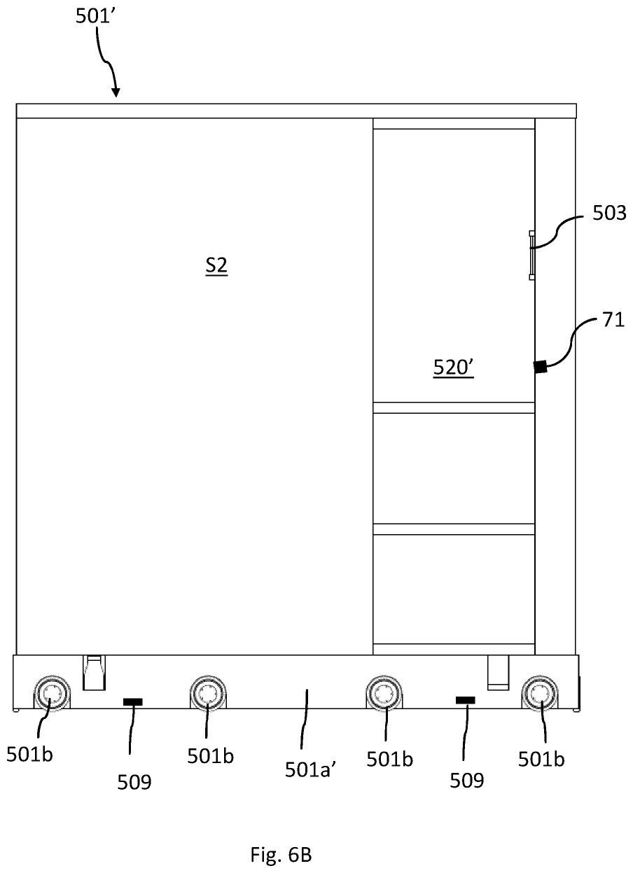

FIG. 6A shows details of an exemplary transport vehicle 501′ for the automated storage and retrieval system 1.

The transport vehicle 501′ vehicle comprises an enclosure E defining an enclosed first area 510 for transporting a person 50 within. The enclosure E is formed by four sides, i.e. first side S1, second side S2, third side S3 and fourth side S4. In the example in FIG. 6 there is arranged one lockable barrier 520′ configured to provide access for a person into the first area 510 on each of the four sides S1,S2,S3,S4 such that the transport vehicle 501′ can connect to a second area 30 arranged on any of the four sides S1,S2,S3,S4.

The transport vehicle 501′ features a vehicle body 501a′. A first set of wheels 501b for driving in the first direction X and a second set of wheels 501c for driving in the second direction Y are arranged on the vehicle body 501a′.

Although not shown, the transport vehicle 501′ preferably comprises a wheel lift mechanism operable between a first position in which the first set of wheels 501b is above the second set of wheels 501c such that the second set of wheels 501c is in contact with the rail system 108, and a second position in which the first set of wheels 501b is below the second set of wheels 501c such that the first set of wheels 501b is in contact with the rail system 108.

Furthermore, although not shown, the transport vehicle 501′ preferably comprises a vehicle drive or wheel drive motor for driving the first set of wheels 501b and/or the second set of wheels 501c for moving the transport vehicle 501′ on the rail system.

The transport vehicle 501′ is preferably in communication with the control system 500 such that the control system 500 gives instructions to the transport vehicle 501′ where to move within the operating area 20 of the rail system 108 without the risk of collision with the container handling vehicles 201,301,501.

The transport vehicle 501′ may further comprise an emergency stop 40. The emergency stop 40 may comprise a transmitter configured to transmit an emergency stop signal to the control system 500. For example, the emergency stop may comprise a transmitter and the control system 500 may comprise a receiver for receiving a signal from the transmitter. The control system may then send stop signal to all container handling vehicles and transport vehicles or it may cut the power.

The transport vehicle 501′ may comprise a lock status detector 71 configured to detect whether the barrier 520′ on the transport vehicle 501′ is unlocked or locked. The lock status detector 71 may comprise a transmitter (not shown) for communication with the control system 500.

The transport vehicle 501′ may comprise one or more supports 509 for stabilizing the transport vehicle 501′. The support 509 is movable between a raised position where it is lifted from the rail system 108 and a lowered position where it is in contact with the rail system 108. The support 509 is preferably configured to interact with the rail system 108. The support 509 may interact with the rail system 108 in order to stabilize the transport vehicle during entering and exit of a person. The support 509 may be used in addition to lowering all wheels into contact with the rail system 108 during entering and exit of a person 50. It may also provide for additional support which may be required when bringing container handling vehicles 201,301,401, tools etc. into or out of the first area 510 of the transport vehicle 501′.

The disclosed transport vehicle 501′ has a footprint on the rail system 108 which covers a total of 12 grid cells 130 (4 grid cells in the first direction X and 3 grid cells in the second direction Y). The control system 500 will then typically take into account the total size of the footprint of the transport vehicle 501′ when providing routing instructions both to the transport vehicle 501′ and to all of the container handling vehicles 201,301,401 within the operating area 20.

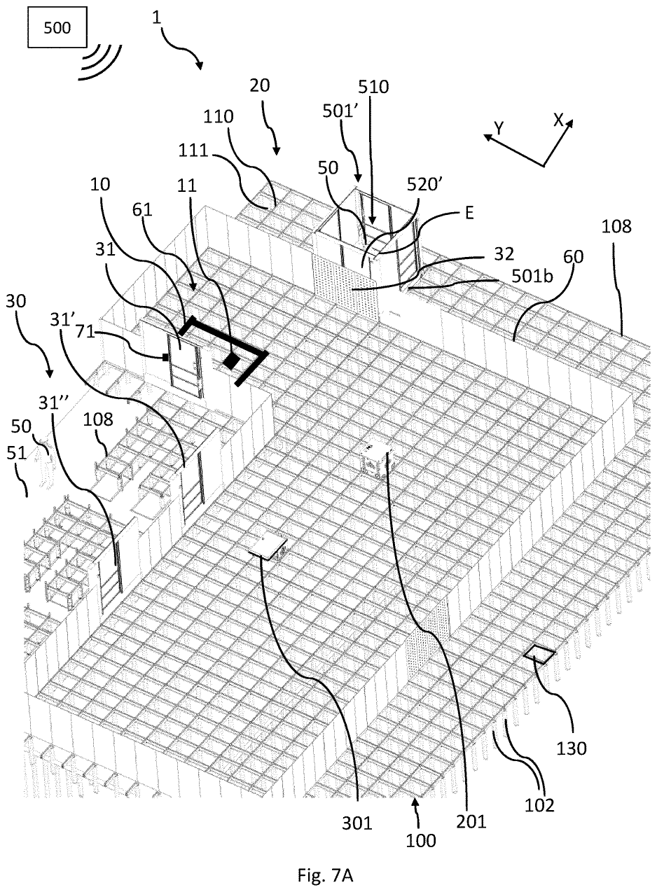

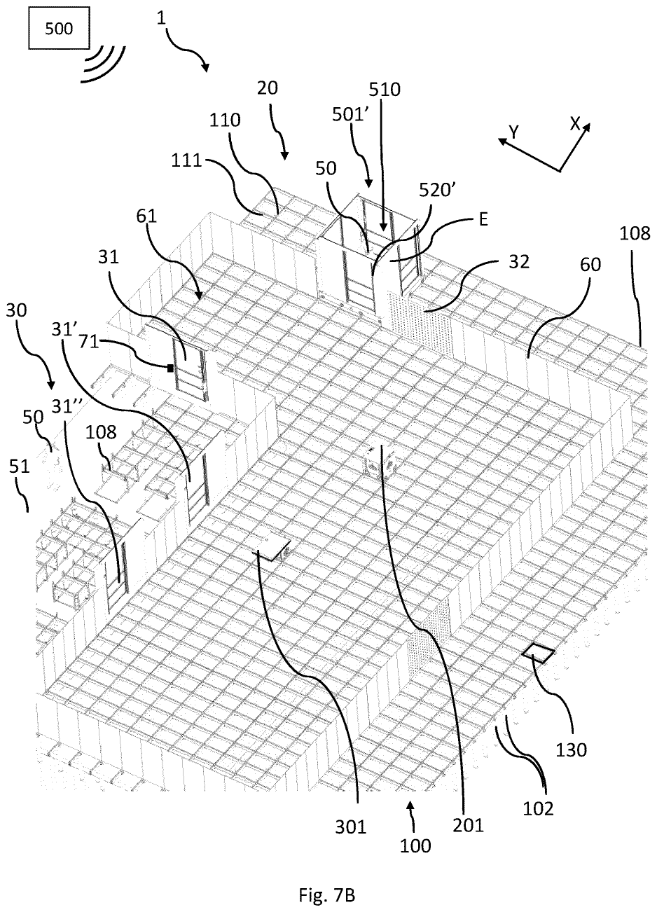

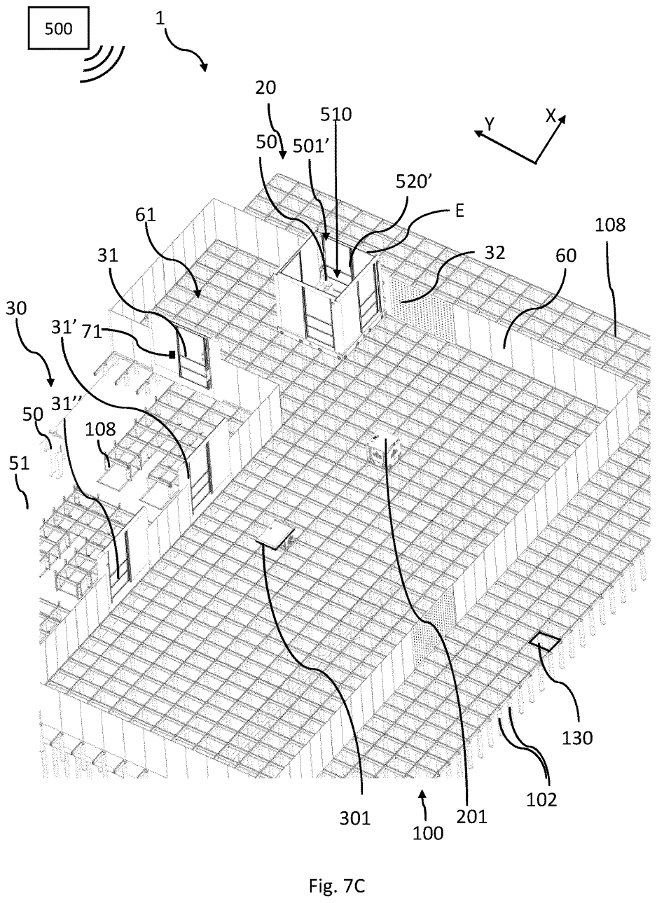

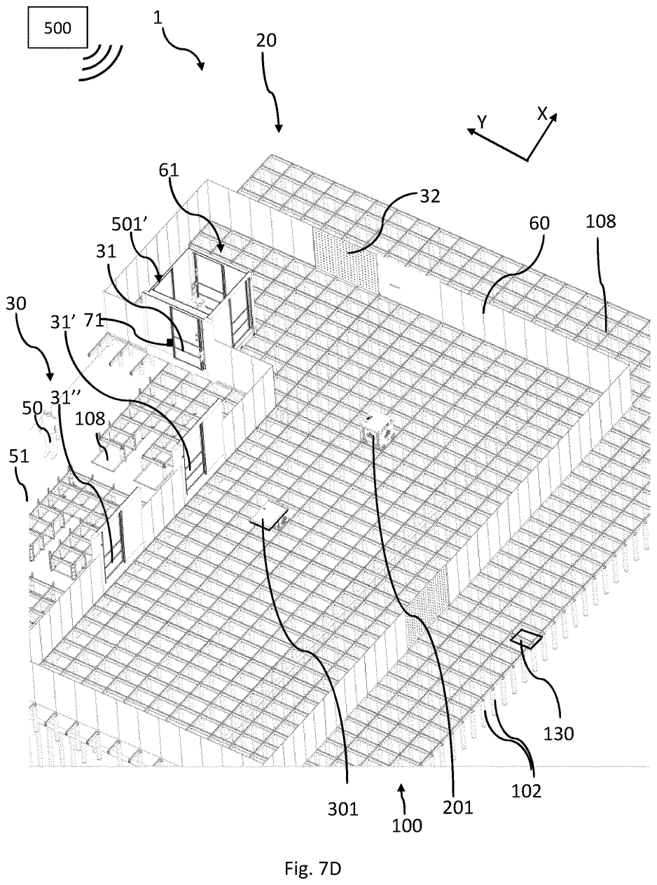

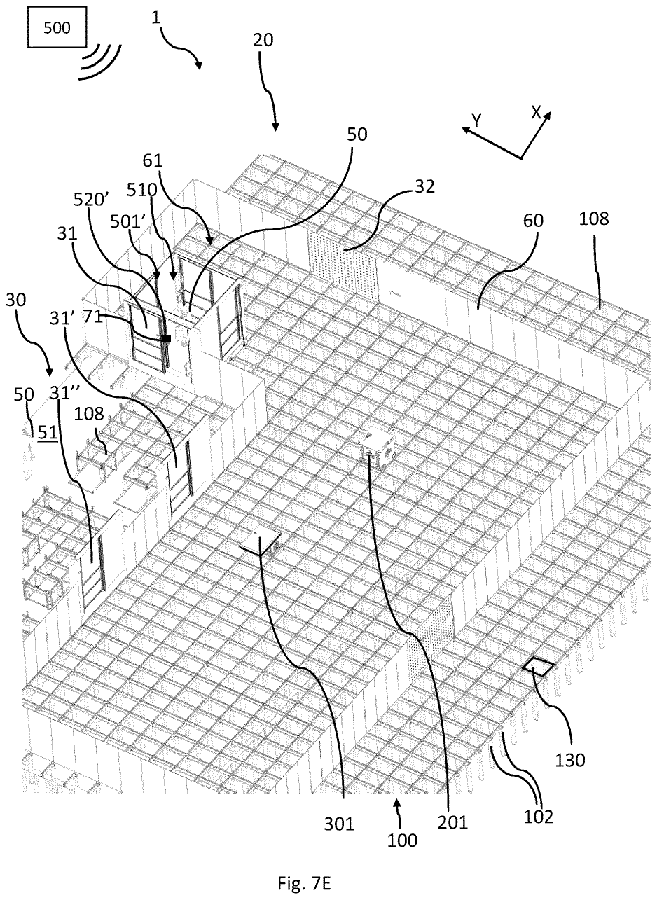

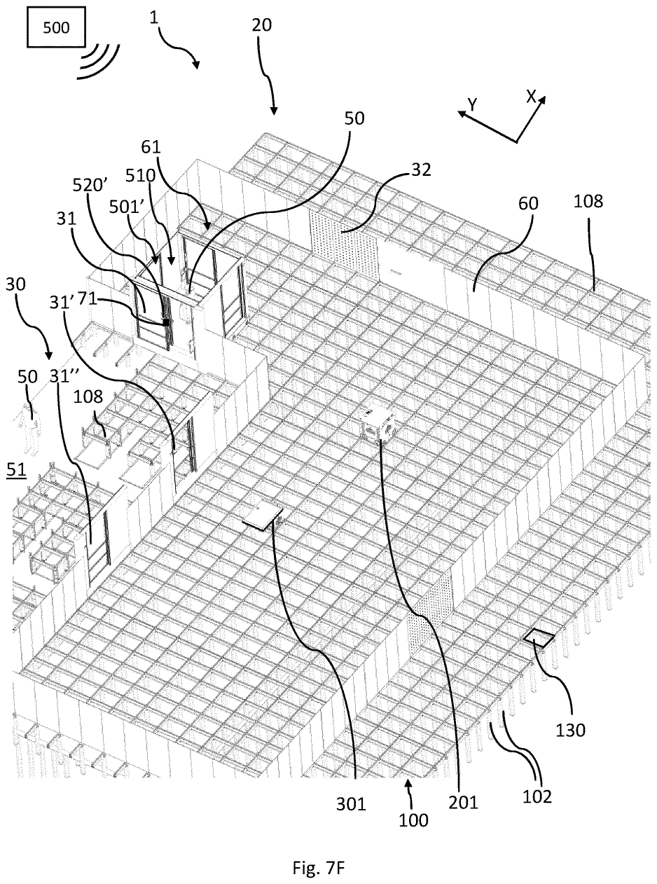

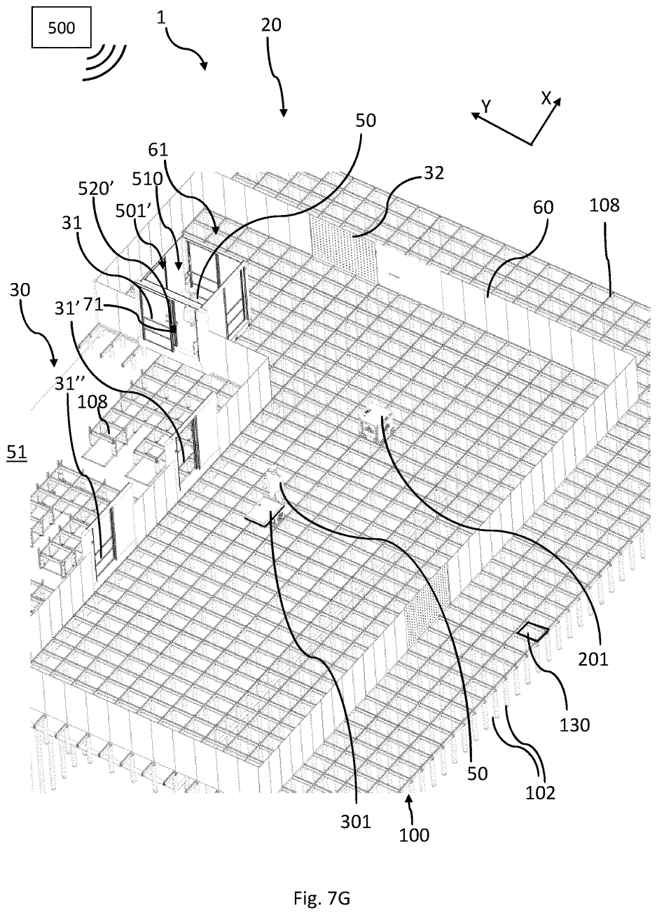

FIG. 6B is a side view of a second example of a transport vehicle 501′ vehicle for the automated storage and retrieval system 1. The transport vehicle 501′ in FIG. 7 has features in common with the exemplary transport vehicle in FIG. 6, which features will not be repeated herein.

FIGS. 7A-7G are perspective views of an automated storage and retrieval system 1 comprising an operating area 20, a second area 30 and a vehicle pen 60 between the operating area 20 and the second area 30, and where the vehicle pen 60 comprises a lockable first barrier 31 separating the vehicle pen area 61 from the second area 30 and a lockable second barrier 32 separating the vehicle pen area 61 from the operating area 20, and where two container handling vehicles 201,301 are positioned within the vehicle pen 60 in all of the FIGS. 7A-7G.

As seen in all of FIGS. 7A-7G, it is shown a rail system 108 comprising a first set of parallel rails 110 extending in a first direction X across the top of a frame structure 100 formed by a plurality of upright members 102, and a second set of parallel rails 111 in the horizontal plane arranged in a second direction Y perpendicular to the first set of parallel rails 110, to guide movement of container handling vehicles 201;301 in the first direction X and the second direction Y. The rail system 108 comprises an operating area 20. The disclosed rail system 108 also extends into the vehicle pen area 61, and partly into the second area 30.

The transport vehicle 501′ is movable on the rail system 108. The transport vehicle is the same as in FIG. 6A and its features will not be repeated herein.

The vehicle pen 60 between the operating area 20 and the second area 30 defines a vehicle pen area 61 and comprises the lockable first barrier 31 for separating the vehicle pen area 61 from the second area 30 and the lockable second barrier 32 for separating the vehicle pen area 61 from the operating area 20. A wall 32 separates the vehicle pen area 61 from the operating area 20 and the second area 30. In FIGS. 7A-7G, a total of three lockable first barriers 31,31′,31″ are shown along the wall 32. The three lockable first barriers 31,31′,31″ are identical and each provide the same function in movement of personnel (or container handling vehicles 201,301,401) between the second area 30 and the vehicle pen area 61 or the first area 510 within the transport vehicle 501′.

The vehicle pen area 61 may comprise a number of parking positions 10 for the transport vehicle 501′ and at least one of the parking positions 10 may comprise means for locking the transport vehicle 501′ in place when positioned at the parking position 10.

The first barrier 31 of the vehicle pen 60 is configured to:
lock when the second barrier 32 of the vehicle pen 60 is unlocked thereby preventing passage of a person 50 therethrough; and
unlock when the second barrier 32 of the vehicle pen 60 is locked thereby allowing passage of a person 50 therethrough, and the lockable barrier 520′ of the transport vehicle 501′ is configured to:
lock when the second vehicle pen barrier 32 of the vehicle pen 60 is unlocked thereby preventing passage of a person 50 therethrough, and
unlocked when the transport vehicle 501′ is positioned within the vehicle pen area 61 and the second vehicle pen barrier 32 of the vehicle pen 60 is locked thereby allowing passage of a person 50 therethrough.

The locking and unlocking of the lockable barrier 520′ of the transport vehicle 501′, the lockable first barrier 31 and the lockable second barrier 32 is controlled by the control system 500, and the different positions will be shown in the following with reference to the views in FIGS. 7A-7G:

In FIG. 7A the transport vehicle 501′ is within the operating area 20. The lockable barrier 520′ of the transport vehicle 501′ is locked, and the first lockable barrier 31 and the second lockable barrier 32 are both locked.

FIG. 7B shows that the lockable barrier 520′ of the transport vehicle 501′ is still locked, the second lockable barrier 32 is unlocked and the first lockable barrier 31 is still locked. By unlocking the lockable second barrier 32, it is possible for the transport vehicle 501′ to enter the vehicle pen 60 through the lockable second barrier 32.

FIG. 7C shows that the lockable barrier 520′ of the transport vehicle 501′ is still locked, the second lockable barrier 32 is still unlocked and the first lockable barrier 31 is still locked. The transport vehicle 501′ has entered the vehicle pen 60 through the lockable second barrier 32.

FIG. 7D shows that the lockable barrier 520′ of the transport vehicle 501′ is still locked, the second lockable barrier 32 is still locked and the first lockable barrier 31 is still locked. The transport vehicle 501′ is positioned next to the lockable first barrier 31 inside the vehicle pen 60.

FIG. 7E shows that the lockable barrier 520′ of the transport vehicle 501′ is unlocked, the second lockable barrier 32 is still locked and the first lockable barrier 31 is unlocked. The lockable first barrier 31 has moved to the side. Similarly, the lockable barrier 520′ of the transport vehicle 501′ has been moved to the side to provide a passage for the person 50. The transport vehicle 501′ is still positioned next to the lockable first barrier 31 inside the vehicle pen 60. The person 50 inside the first area 510 of the transport vehicle 501′ can now exit the transport vehicle 501 through the vehicle barrier 520′ and the lockable first barrier 31.

FIG. 7F is a similar view as FIG. 7E, but where another lockable first barrier 31′ between the vehicle pen area 61 and the second area 60 is unlocked and the lockable barrier 520′ of the transport vehicle 501′ is still unlocked.

FIG. 7G is a similar view as FIG. 7F, but where the person 50 has moved from the second area 30 and entered the vehicle pen area 61 through the unlocked lockable first barrier 31′ between the vehicle pen area 61 and the second area 30.

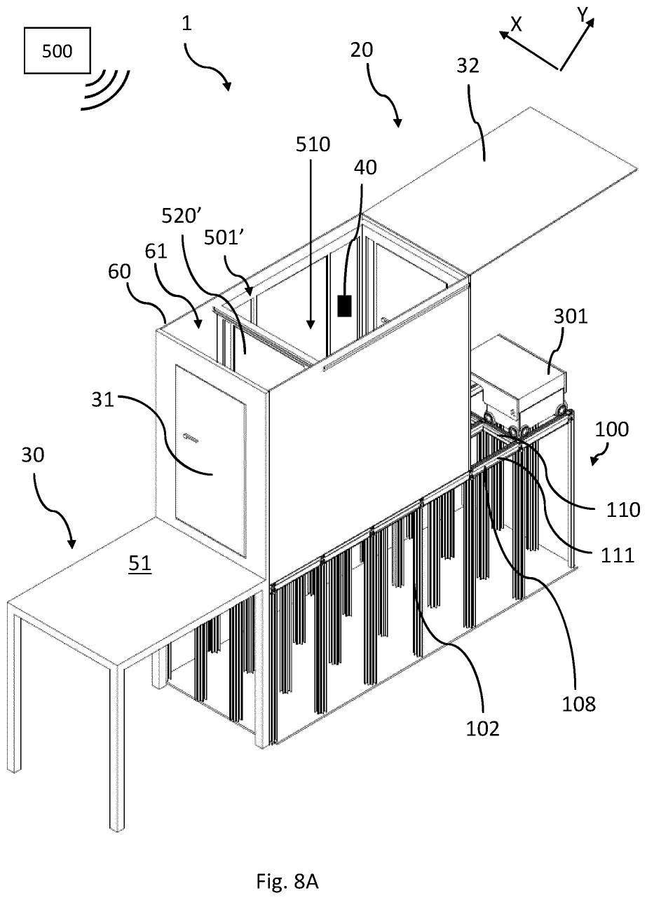

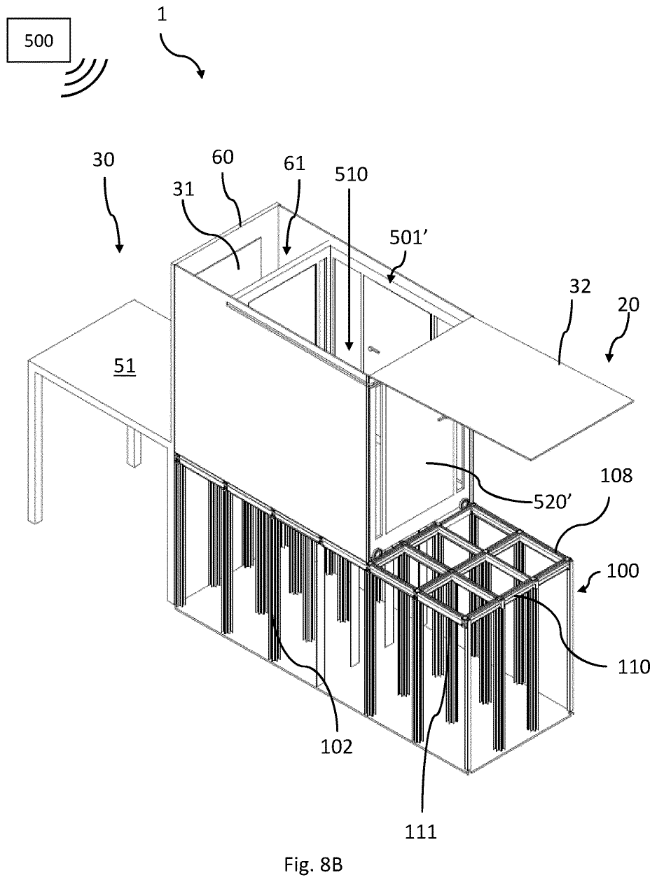

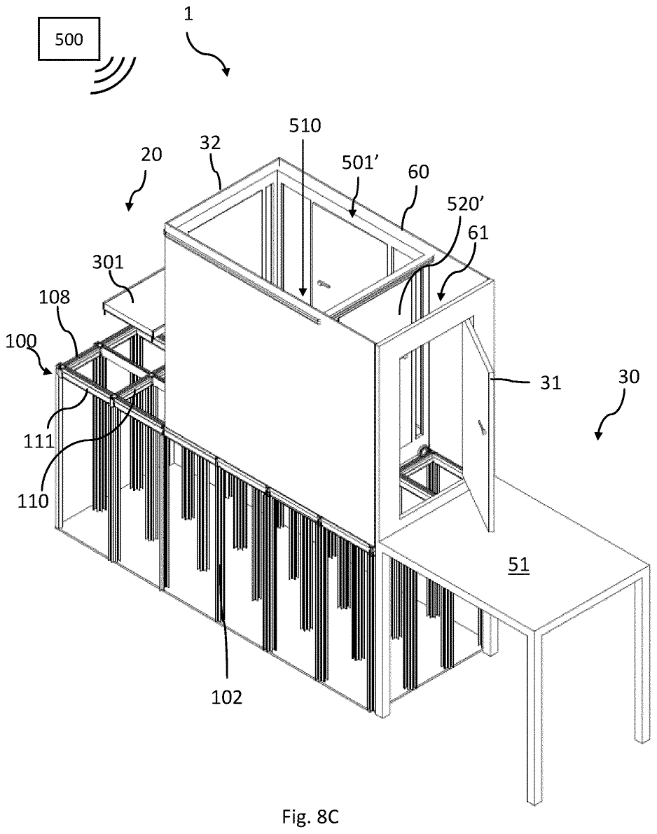

FIGS. 8A-8C are perspective views of an automated storage and retrieval system 1 comprising an operating area 20, a second area 30 and a vehicle pen 60 between the operating area 20 and the second area 30. A transport vehicle 501′ as exemplified in FIG. 6B is positioned inside the vehicle pen 60. The vehicle pen 60 is of substantially the same size as the transport vehicle 501′ such that only one transport vehicle 501′ can be positioned inside the vehicle pen 60 at the time.

As seen in all of FIGS. 8A-8C, it is shown a rail system 108 comprising a first set of parallel rails 110 extending in a first direction X across the top of a frame structure 100 formed by a plurality of upright members 102, and a second set of parallel rails 111 in the horizontal plane arranged in a second direction Y perpendicular to the first set of parallel rails 110, to guide movement of container handling vehicles 201;301 (only one container handling vehicle 301 shown in the operating area 20) in the first direction X and the second direction Y. The rail system 108 comprises an operating area 20. The disclosed rail system 108 also extends into the vehicle pen area 61. The second area has a floor 51 and no rails.

The vehicle pen 60 between the operating area 20 and the second area 30 defines a vehicle pen area 61 and comprises the lockable first barrier 31 for separating the vehicle pen area 61 from the second area 30 and the lockable second barrier 32 for separating the vehicle pen area 61 from the operating area 20. A wall 32 separates the vehicle pen area 61 from the operating area 20 and the second area 30.

The first barrier 31 of the vehicle pen 60 is configured to:
lock when the second barrier 32 of the vehicle pen 60 is unlocked thereby preventing passage of a person 50 therethrough; and
unlock when the second barrier 32 of the vehicle pen 60 is locked thereby allowing passage of a person 50 therethrough, and the lockable barrier 520′ of the transport vehicle 501′ is configured to:
lock when the second vehicle pen barrier 32 of the vehicle pen 60 is unlocked thereby preventing passage of a person 50 therethrough, and
unlocked when the transport vehicle 501′ is positioned within the vehicle pen area 61 and the second vehicle pen barrier 32 of the vehicle pen 60 is locked thereby allowing passage of a person 50 therethrough.

The locking and unlocking of the lockable barrier 520′ of the transport vehicle 501′, the lockable first barrier 31 and the lockable second barrier 32 is controlled by the control system 500, and the different positions will be shown in the following with reference to the views in FIGS. 8A-8C:

FIG. 8A shows that the lockable first barrier 31 separating the vehicle pen area 61 from the second area 30 is locked and the lockable second barrier 32 separating the vehicle pen area 61 from the operating area 20 is unlocked.

FIG. 8B shows the same as FIG. 8A but from an opposite side than FIG. 8A.

FIG. 8C shows that the lockable first barrier 31 separating the vehicle pen area 61 from the second area 30 is unlocked and the lockable second barrier 32 separating the vehicle pen area 61 from the operating area 20 is locked. Although not shown in FIG. 8C, the lockable barrier 520′ can now be unlocked such that a person can enter or exit the first area 510 from the second area 30.

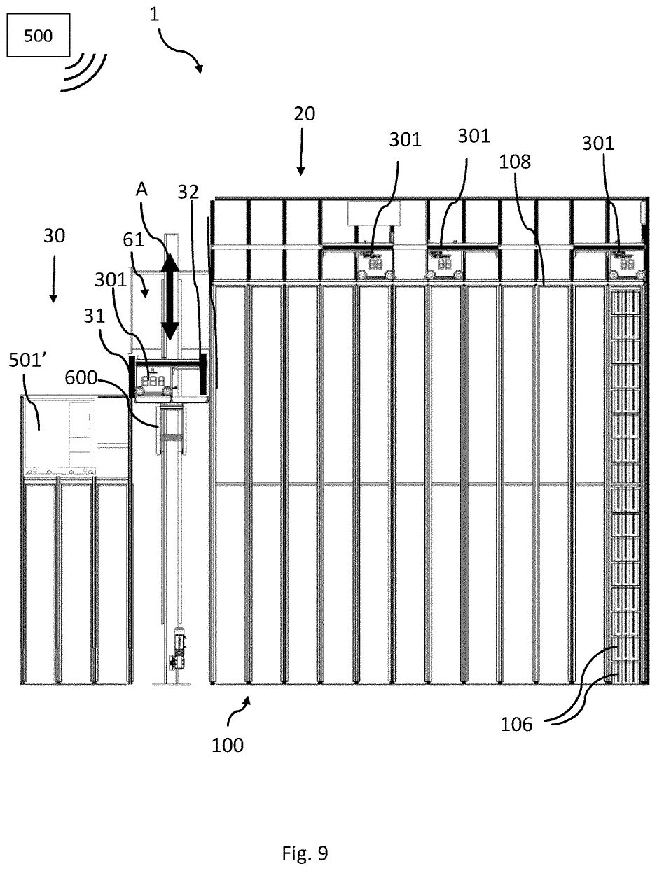

FIG. 9 shows an automated storage and retrieval system 1 where the operating area 20 and the second area 30 are at different heights and where the vehicle pen 60 is an elevator 600 for the container handling vehicles and the transport vehicle 501′. The elevator 600 can transport the container handling vehicles 201,301,401 and the transport vehicle 501′ between the operating area 20 and the second area 30. In FIG. 9, a prior art container handling vehicle 301 is arranged in the elevator 600 at the level of the second area 30. The vehicle pen 60, i.e. the elevator 600, comprises the lockable first barrier 31 towards the second area 30 and the lockable second barrier 32 towards the operating area 20. The first barrier 31 and the second barrier 32 follows the vertical movement of the elevator 600. Movement of the elevator 600 is indicated by arrow A.

With reference to the different examples of automated storage and retrieval system shown in FIGS. 7-9, an example method sequence of moving a transport vehicle 501′ from the operating area 20 into the vehicle pen area 61 in an automated storage and retrieval system 1 by using a control system 500 may comprise the steps of:
request unlocking of the lockable second barrier 32;
verify that the first barrier 31 is locked, if not wait for the first barrier 31 to lock;
change state of the lockable second barrier 32 to unlock;
instruct the transport vehicle 501 to enter into the vehicle pen area 61 through the second barrier 32;
request locking of the second barrier 32;
set vehicle drive to inhibited mode;
set vehicle wheel lift mechanism to inhibited mode;
request the lockable barrier 520′ of the transport vehicle 520′ to unlock, verify that the second barrier 32 is locked, if not wait for the second barrier 32 to lock;
request unlocking of the lockable first barrier 31;
change state of the lockable barrier 520′ to unlocked;
change state of the lockable first barrier 31 to unlocked;
enter or exit the transport vehicle 501′ to or from the second area 30 through the lockable barrier 520′ and the first barrier 31.

With reference to the different examples of automated storage and retrieval system shown in FIGS. 7-9, an example method sequence of moving a transport vehicle 501′ from a vehicle pen area 61 to an operating area 20 in an automated storage and retrieval system 1 by using a control system 500 may comprise the steps of:
request the lockable barrier 520′ to unlock;
request the lockable first barrier 31 to unlock;
verify that the second barrier 32 is locked, if not wait for the second barrier 32 to lock;
enter the transport vehicle 520′;
request the lockable barrier 520′ to lock;
change state of lockable barrier 520′ to locked;
request the first barrier 31 to lock;
change state of the first barrier 31 to locked;
set vehicle drive to operation mode;
set vehicle wheel lift mechanism to operation mode;
request the lockable second barrier 32 to unlock;
instruct the transport vehicle 501′ to exit the vehicle pen area 61 and enter into the operational area 20 via the lockable second barrier 32.

In the preceding description, various features of the embodiments have been described. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention as defined in the attached claims.

List of reference numbers

| | |
|---|---|
| 1 | Prior art automated storage and retrieval system |
| 10 | Parking position |
| 11 | Means for locking the transport vehicle |
| 20 | Operating area |
| 21 | |
| 30 | Second area/service area |
| 31, 31′, 31″ | Lockable first barrier |
| 32 | Lockable second barrier |
| 40 | Emergency stop |
| 50 | Person/operator |
| 60 | Vehicle pen |
| 61 | Vehicle pen area |
| 60 | Person |
| 71 | Lock status detector |
| 100 | Frame structure |
| 102 | Upright member |
| 104 | Storage volume |
| 105 | Storage column |
| 106 | Storage container |
| 106′ | Particular position of storage container |
| 107 | Stack |
| 108 | Rail system |
| 110 | First set of parallel rails (in first direction (X)) |
| 111 | Second set of parallel rails (in second direction (Y)) |
| 112 | Access opening |
| 116 | Lifting device |
| 119 | Delivery column |
| 120 | Delivery column |
| 130 | Grid cell |
| 201 | Prior art container handling vehicle |
| 201a | Vehicle body of the container handling vehicle 201 |
| 201b | Drive means/wheel arrangement/first set of wheels |
| | in first direction (X) |
| 201c | Drive means/wheel arrangement/second set of wheels |
| | in second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 302 | Cantilever |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system (500) |
| 501′ | Transport vehicle |
| 501a | Vehicle body of the first transport vehicle 501′ |
| 501b | First drive means/wheel arrangement/first set of |
| | wheels in first direction (X) |
| 501c | Second drive means/wheel arrangement/second set of |
| | wheels in second direction (Y) |
| 510 | First area |
| 520′ | Lockable vehicle barrier of the transport vehicle 501′ |
| 600 | Elevator |
| X | First direction |
| Y | Second direction |
| Z | Third direction |

1-26. (canceled)

27. An automated storage and retrieval system comprising:
a rail system comprising a first set of parallel rails extending in a first direction across the top of a frame structure formed by a plurality of upright members, and a second set of parallel rails in a horizontal plane arranged in a second direction perpendicular to the first set of parallel rails, to guide movement of a plurality of container handling vehicles in the first direction and the second direction, and wherein the rail system comprises an operating area for operating said plurality of container handling vehicles in the operating area;
a transport vehicle movable on the rail system, the transport vehicle comprising an enclosure defining an enclosed first area for transporting a person within, the enclosure comprising a lockable barrier configured to provide access for a person into the first area;
a second area partitioned from the operating area;
a vehicle pen between the operating area and the second area, wherein the vehicle pen defines a vehicle pen area and comprises a lockable first barrier for separating the vehicle pen area from the second area, and a lockable second barrier for separating the vehicle pen area from the operating area;
wherein the first barrier of the vehicle pen is configured to:
lock when the second barrier of the vehicle pen is unlocked thereby preventing passage of a person therethrough; and
unlock when the second barrier of the vehicle pen is locked thereby allowing passage of a person therethrough, and
wherein the lockable barrier of the transport vehicle is configured to:
lock when the second vehicle pen barrier of the vehicle pen is unlocked thereby preventing passage of a person therethrough, and
unlock when the transport vehicle is positioned within the vehicle pen area and the second vehicle pen barrier of the vehicle pen is locked thereby allowing passage of a person therethrough.

28. The automated storage and retrieval system according to claim 27, wherein the vehicle pen comprises rails for guiding movement of the container handling vehicles and the transport vehicle.

29. The automated storage and retrieval system according to claim 27, wherein the vehicle pen area comprises a number of parking positions for the transport vehicle and wherein at least one of the parking positions comprises means for locking the transport vehicle in place when positioned at the parking position.

30. The automated storage and retrieval system according to claim 29, wherein the locking means comprises a brake or stake to lock with the rails.

31. The automated storage and retrieval system according to claim 27, wherein the barrier of the transport vehicle and the first barrier of the vehicle pen are fail-safe locked.

32. The automated storage and retrieval system according to claim 27, wherein the transport vehicle comprises a first set of wheels for driving in the first direction and a second set of wheels for driving in the second direction.

33. The automated storage and retrieval system according to claim 32, wherein the transport vehicle comprises a wheel lift mechanism operable between a first position in which the first set of wheels is above the second set of wheels such that the second set of wheels is in contact with the rail system, and a second position in which the first set of wheels is below the second set of wheels such that the first set of wheels is in contact with the rail system.

34. The automated storage and retrieval system according to claim 32, wherein the transport vehicle comprises a wheel drive motor for driving the first set of wheels and/or the second set of wheels.

35. The automated storage and retrieval system according to claim 27, wherein the system comprises a control system which comprises a transmitter and a receiver for communication with the container handling vehicles and the transport vehicle.

36. The automated storage and retrieval system according to claim 35, wherein the transport vehicle comprises an emergency stop, wherein the emergency stop comprises a transmitter configured to transmit an emergency stop signal to the control system for shutting down the automated storage and retrieval system.

37. The automated storage and retrieval system according to claim 35, wherein the transport vehicle is configured to receive routing instructions from the control system to a position inside the vehicle pen area, and when it is verified that the transport vehicle is in the vehicle pen area and the second vehicle pen barrier is locked and the vehicle barrier and the first vehicle pen barrier are open, passage of a person therethrough is allowed.

38. The automated storage and retrieval system according to claim 37, wherein the control system comprises a verification device for verifying that the transport vehicle is inside the vehicle pen area.

39. The automated storage and retrieval system according to claim 38, wherein the verification device comprises one or more sensors.

40. The automated storage and retrieval system according to claim 27, wherein the transport vehicle comprises a locking mechanism and the vehicle pen area comprises a complementary locking mechanism such as to prevent unintentional movement of the transport vehicle when in the vehicle pen area.

41. The automated storage and retrieval system according to claim 40, wherein the locking mechanism of the vehicle pen area is arranged at the first barrier such that the first barrier can only be unlocked when all of the transport vehicles present within the vehicle pen area are locked to the first barrier.

42. The automated storage and retrieval system according to claim 27, wherein the transport vehicle comprises a support to help stabilize the transport vehicle.

43. The automated storage and retrieval system according to claim 42, wherein the support is movable between a raised position where it is lifted from the rail system and a lowered position where it is in contact with the rail system.

44. The automated storage and retrieval system according to claim 27, wherein the second area is a safe area for performing service on the container handling vehicles and where the container handling vehicles are prevented from self-movement.

45. The automated storage and retrieval system according to claim 28, wherein the operating area and the second area are at the same height and wherein the rails of the vehicle pen are connected to the rails of the operating area such that the transport vehicle and the container handling vehicles can move on the rails when entering and exiting the vehicle pen area through the lockable first barrier.

46. The automated storage and retrieval system according to claim 28, wherein the operating area and the second area are arranged at different heights and where the vehicle pen is an elevator for transporting the container handling vehicles and the transport vehicle between the operating area and the second area.

47. The automated storage and retrieval system according to claim 27, wherein the second area is an area within the operating area.

48. The automated storage and retrieval system according to claim 27, wherein the system comprises a vehicle pen confirmation device operable by the person such that the person can confirm entry or exit into or out of the vehicle pen area) through the first barrier of the vehicle pen.

49. The automated storage and retrieval system according to claim 27, wherein the transport vehicle comprises an activation device operable by the person such that the person can confirm entry or exit into or out of the transport vehicle through the barrier of the transport vehicle.

50. The automated storage and retrieval system according to claim 48, wherein the second barrier of the vehicle pen is configured to be unlocked either:
if the person has confirmed entry into the transport vehicle via the activation device, or
if the person has confirmed exit out of the vehicle pen area via the vehicle pen confirmation device.

51. A method of moving a transport vehicle from an operating area into a vehicle pen area in an automated storage and retrieval system according to claim 27, the transport vehicle comprising a vehicle drive for self-movement and a wheel lift mechanism for changing movement direction and an enclosure which defines an enclosed first area for transporting a person within, the enclosure comprising a lockable barrier configured to provide access for a person into the first area, wherein the method comprises using a control system to:
request unlocking of the lockable second barrier;
verify that the first barrier is locked, if not wait for the first barrier to lock;
change state of the lockable second barrier to unlock;
instruct the transport vehicle to enter into the vehicle pen area through the second barrier;
request locking of the second barrier;
set vehicle drive to inhibited mode;
set vehicle wheel lift mechanism to inhibited mode;
request the lockable barrier of the transport vehicle to unlock, verify that the second barrier is locked, if not wait for the second barrier to lock;
request unlocking of the lockable first barrier;
change state of the lockable barrier to unlocked;
change state of the lockable first barrier to unlocked;
enter or exit the transport vehicle to or from the second area through the lockable barrier and the first barrier.

52. A method of moving a transport vehicle from a vehicle pen area to an operating area in an automated storage and retrieval system according to claim 27, the transport vehicle comprising a vehicle drive for self-movement and a wheel lift mechanism for changing movement direction and an enclosure which defines an enclosed first area for transporting a person within, the enclosure comprising a lockable barrier configured to provide access for a person into the first area, wherein the method comprises using a control system to:
request the lockable barrier to unlock;
request the lockable first barrier to unlock;
verify that the second barrier is locked, if not wait for the second barrier to lock;
enter the transport vehicle;
request the lockable barrier to lock;
change state of lockable barrier to locked;
request the first barrier to lock;
change state of the first barrier to locked;
set vehicle drive to operation mode;
set vehicle wheel lift mechanism to operation mode;
request the lockable second barrier to unlock;
instruct the transport vehicle to exit the vehicle pen area and enter into the operational area via the lockable second barrier.
